(19) United States
(12) Patent Application Publication
(10) Pub. No.: US 2008/0131333 A1
(43) Pub. Date: Jun. 5, 2008

(54) Lateral-flow waste gas treatment device using nonthermal plasma

(75) Inventors: Chin-Ching Tzeng, Yonghe City (TW); Shiaw-Huei Chen, Yonghe City (TW)

Correspondence Address: TROXELL LAW OFFICE PLLC, 5205 LEESBURG PIKE, SUITE 1404, FALLS CHURCH, VA, 22041, US

(73) Assignees: High Power-Factor AC/DC Converter with Parallel Power Processing, Taoyuan (TW); Atomic Energy Council-Institute of Nuclear Energy Research

(21) Appl. No.: 11/607,890

(22) Filed: Dec. 4, 2006

(51) Int. Cl. B01D 53/32

(52) U.S. Cl. 422/168

(57) ABSTRACT

A lateral-flow dielectric barrier discharging reactor unit is designed to effectively process waste gas. Nonthermal plasma is obtained through high voltage gas breakdown for processing the waste gas. Reactor units can be arranged and integrated in a serial and/or parallel way with flow uniformity and smoothness for processing a great amount of waste gas with merits of simplicity and low cost.

### FIELD OF THE INVENTION

The present invention relates to a device for waste gas treatment; more particularly, relates to obtaining a nonthermal plasma through a high voltage discharging device for processing waste gas.

### DESCRIPTION OF THE RELATED ARTS

A nonthermal plasma (NTP) device used for processing waste gas is obtained first by high temperature free electrons through high-voltage discharging in a gas, and then the electrons collides with other gas molecules to form free radicals, like excited atom and molecules of N, O, OH and O₃, for oxidizing or reducing waste gas into harm less gas rapidly. In the whole process, the energy used is mainly added on the electrons while the gas molecule itself has little increase in energy; so, the temperature of the electrons is much higher than that of the gas molecule, which is thus called NTP. By using this method, a great amount of low-concentration polluted waste gas can be processed with saved energy yet high efficiency.

A design of a high-voltage plasma reactor is closely related to its target. There are two types of plasma reactors, a pipe plasma reactor and a flat plasma reactor, used in processing waste gas. The flat plasma reactor has a smooth gas flow, but discharging uniformity is weakened owing to increase in the flat area; and so its efficiency and flow amount is reduced. Hence, it is rarely used to process a great amount of waste gas. The pipe plasma reactor further has two types of reactors, a pulse-corona plasma reactor and a dielectric barrier discharging (DBD) plasma reactor. The pulse-corona one has no insulating material to separate discharging electrodes. So, to keep from arcing, a high voltage short pulse, which is shorter than 1 microsecond, is used. This method has a high efficiency on processing waste gas, which is used in U.S. Pat. No. 4,695,358 in 1985. Yet, especially in processing a great amount of waste gas, owing to the too high cost to produce the high voltage short pulse with increased high power, it is not economically competitive on applying this method. And on considering the dielectric barrier discharging reactor, one or two insulating material are used to separate discharging electrodes so that a general high voltage alternating current power source can be used to reduce cost in installing the power source. This DBD method is originated from W. Siemens in 1857 for producing ozone and is used till now without great changes. In the other hand, the pipe DBD plasma reactor may be packed with insulating pellets having high dielectric permittivity, which is used in U.S. Pat. No. 5,236,672 in 1993 and U.S. Pat. No. 5,440,876 in 1995.

The general pipe plasma reactor has a straight flow design; that is, the axle of the flow has the same direction as that of the reactor. When enlarging a pipe's diameter to process a great amount of waste gas, the applied high voltage may be increased to an undesirable degree, not to mention the high operation cost in maintenance and safety assurance owing to the severe insulation protection. Therefore, a few reactors connected in a serial and parallel way are usually used in processing a great amount of waste gas Yet, the uniformity of discharging in each reactor has to be put into consideration; the inside flow has to be smooth and evenly distributed; and, load for every reactor has to be consistent. Moreover, any possible connection between the high-voltage electrodes has to be prevented and the insulation design should not affect distribution of the gas flow. However, settlement of the high-voltage wires, distribution of the gas flow and related maintenance considerations are all critical as well, so that complexity of the whole system increases which follows with heightened difficulties. Hence, the prior arts do not fulfill users' requests on actual use.

### SUMMARY OF THE INVENTION

The main purpose of the present invention is to obtain a nonthermal plasma through a high voltage discharging device for processing a great amount of waste gas.

To achieve the above purpose, the present invention is a lateral-flow nonthermal plasma waste gas treatment device, comprising a plurality of lateral-flow DBD reactor units in a serial and parallel connection; and a plurality of airflow stoppers between lateral-flow DBD reactor units, where the lateral-flow DBD reactor unit comprises a perforated outer electrode, a center electrode, an insulating layer and a high voltage power source; the perforated outer electrode is a grounding cathode whose surface has a plurality of through holes; the center electrode is an anode inside the outer electrode; the insulating layer is located between the perforated outer electrode and the center electrode; the high voltage power source is coup led with the perforated outer electrode and the center electrode; and a required NTP is provided through a breakdown voltage discharging between the perforated outer electrode and the center electrode by using lateral-flow reactor units which is serial and parallel arranged to process a great amount of waste gas with an easy assembly and a low cost. Accordingly, a novel lateral-flow waste gas treatment device using nonthermal plasma DBD reactor units is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the sectional view showing the lateral-flow DBD reactor unit of the preferred embodiment according to the present invention;

FIG. 2 is the view showing the state of use of the lateral-flow reacting

FIG. 3 is the top-down view showing the state of use of the preferred embodiment; and

FIG. 4 is the perspective sectional view showing the state of use of the preferred embodiment.

### DESCRIPTION OF THE PREFERRED EMBODIMENT

The following description of the preferred embodiment is provided to understand the features and the structures of the present invention.

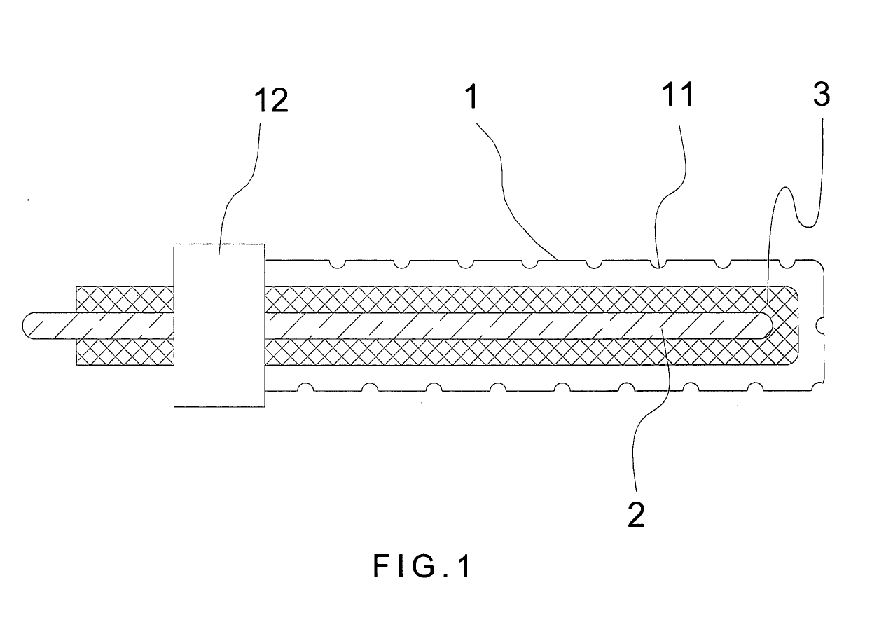

Please refer to FIG. 1, which is a sectional view showing a lateral-flow DBD reactor unit of a preferred embodiment according to the present invention. As shown in the figure, the present invention is a lateral-flow waste gas treatment device using a nonthermal plasma, comprising a plurality of lateral-flow DBD reactor units and a plurality of airflow stoppers (not shown in the figure), where the lateral-flow reactor units comprises a perforated outer electrode 1, a center electrode 2, an insulating layer 3 and a high voltage power source 4; and the lateral-flow DBD reactor units can be arranged and integrated a serial and parallel connection to process waste gas which is flowed through a high-voltage discharging area interacting with the nonthermal plasma generated within.

The perforated outer electrode 1 is a grounding cathode and has a plurality of through holes 11 and a fixing flange 12. The perforated outer electrode is a cylinder tube made of a metal conductive material, which is an alloy of stainless steel, copper, iron or aluminum, etc. On fabricating the perforated outer electrode 1, a thin metal plate is made into a cylinder tube with a plurality of through holes 11 on outer surface and a fixing flange 12 is assembled together to obtain a whole one. The fixing flange 12 is made of a metal conductive material with four to six holes for fixation and connection. Total area of the through holes 11 occupies 40 percents (%) to 60% of the outer surface of the cylinder tube; and the cylinder tube thus obtains uniform discharging. The metal plate of the perforated outer electrode 1 has a thickness between 0.8 and 3 millimeters (mm), a length of tube between 60 and 150 centimeters (cm), and a tube diameter between 8 cm and 10 cm; and the through hole has a diameter between 0.5 cm and 1 cm.

The center electrode 2 is located inside the outer electrode 1 to be an a node. The center electrode 2 is a tube made of a metal conductive material, which is stainless steel or copper, etc. A diameter of the center electrode 2 is between 0.5 cm and 3 cm according to an actual requirement.

The insulating layer 3 is located between the outer electrode 1 and the center electrode 2, covered on the center electrode 2. The insulating layer 3 is a tube made of an insulating material, which is polytetrafluoro-ethylene (PTFE), polyethylene (PE), ceramics, glass or quartz, etc. The insulating layer 3 has a thickness and discharge gap which values depend on actual operational consideration, where usually the thickness is set between 0.3 cm and 1.5 cm and the discharge gap has a width range between 1.5 cm and 5 cm.

The high voltage power supply source 4 is electrically coup led with the perforated outer electrode 1 and the center electrode 2 to supply a high voltage for gas breakdown. The high voltage power source 4 can be a high voltage alternating current (HVAC) 60/50 Hz frequency power source or a high frequency HVAC power source, which has an operating voltage between 10 kilo-volt (kV) and 60 kV according to the discharge gap, and an operating frequency between 50 and 10 kHz. Thus, a novel lateral-flow waste gas treatment device using nonthermal plasma reactor units is obtained.

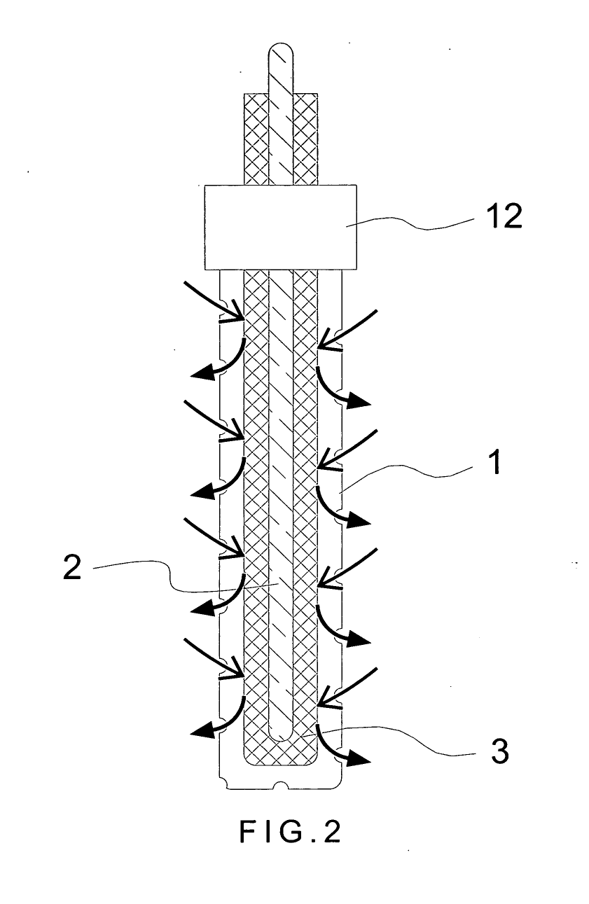

Please refer to FIG. 2, which is a view showing a state of use of a lateral-flow reactor unit. As shown in the figure, when using a lateral-flow DBD reactor unit according to the present invention, a waste gas enters from a plurality of through holes 11 on one side of the perforated outer electrode 1 of the lateral-flow reactor unit. Because the perforated outer electrode 1 and the center electrode 2 are supplied with a high voltage power by a high voltage power source, nonthermal plasma (NTP) by a breakdown voltage and ionization is obtained in the air between discharge gaps of the outer electrode 1 and an insulating layer 3. Then a plurality of highly active free radicals, like excited molecules of N, O, OH and O₃, is obtained by collisions, and to react with the waste gas for obtaining a harmless gas to be outputted from the through holes 11 at another side of the perforated outer electrode 1.

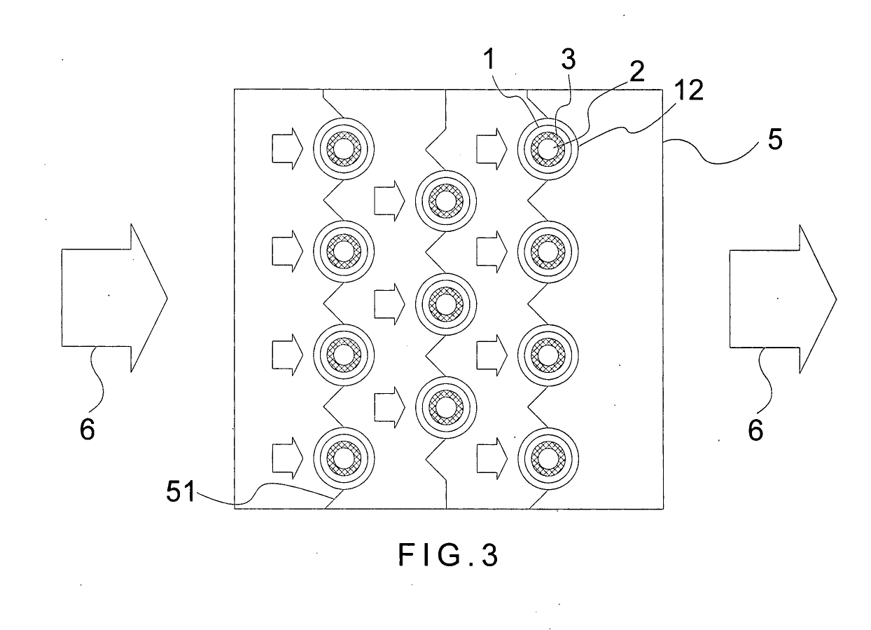

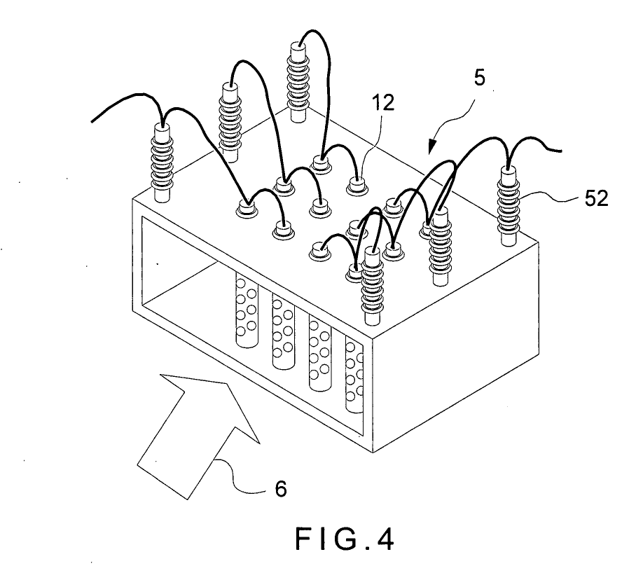

Please refer to FIG. 3 and FIG. 4, which are a top-down view and a perspective sectional view showing a state of use of the preferred embodiment. As shown in the figures, the lateral-flow reactor units are connected in a serial and/or parallel way to be assembled with a plurality of airflow stoppers for obtaining the present invention. At first, a plurality of the lateral-flow DBD reactor unit is put into a container 5 having an interlaced or non-interlaced serial or parallel or serial-and-parallel assembly And an airflow stopper 51 is set between each two adjacent lateral-flow reactor units to assure the waste gas to enter from the through holes 11 at a side on the perforated outer electrode 1 of the lateral-flow DBD reactor unit to flow through a discharging are a for obtaining NTP and then to be outputted from through holes 11 at another side. In the container 5, waste gas is guided to flow through a closed space of the discharging area of the lateral-flow reactor units to becoming a harmless gas after plasma chemical interactions. And then the processed gas is outputted from another direction of the container 5. On the top of the container 5, there are high voltage connections. At two sides on the top of the container 5, a plurality of insulating cylinders 52 is deposed to obtain high voltage power source. And the bulk shell of the container 5 is electrically grounded for safety concern. Because electricity connection is separated from gas flow path in the present invention, undisturbed by the electric wiring the flow field of the processed waste gas is easily designed to obtain smoothness and uniformity, and relative load in the lateral-flow reactor units is uniform distributed. Besides, because the high-voltage electricity is located only on the top of the container 5, the installation and maintenance of the lateral-flow DBD reactor unit becomes easy, where each component can be disassembled for maintaining individually. The actual number and connection of the lateral-flow reactor units are considered according to installation place, waste gas amount, power consumption and gas staying duration time etc., for fulfilling regulations and obtaining a waste gas processing rate greater than 90 percents (%). In the other hand, the high voltage power supply can be a set or sets of high voltage power supplies according to cost-efficiency effect and economic consideration.

Moreover, a most beneficial device can be designed by a serial and parallel connection of the lateral-flow reacting units for future needs. In the other hand, owing to the modular design of the present invention, costs on fabrication and maintenance can be greatly reduced.

To sum up, the present invention is a lateral-flow waste gas treatment device using nonthermal plasma reactor units, where plasma is obtained by high voltage gas breakdown for processing waste gas and a plurality of the present inventions can be arranged in a serial and/or parallel way to increase processing time and staying duration of time of the waste gas, to achieve high removal efficiency.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A lateral-flow waste gas treatment device using nonthermal plasma, comprising:
(a) a plurality of lateral-flow dielectric barrier discharge (DBD) reactor units, said lateral-flow comprising:
(i) a perforated outer electrode, said perforated outer electrode being a grounding electrode, said perforated outer electrode comprising a cylinder tube and a fixing flange, said cylinder tube and said fixing flange being assembled together, said cylinder tube comprising a plurality of through holes;
(ii) a center electrode, said center electrode being located in said outer electrode, said center electrode being an anode;
(iii) an insulating layer, said insulating layer being located between said outer electrode and said center electrode; and
(iv) a high voltage power source, said high voltage power source electrically being coupled with said outer electrode and said center electrode, said high voltage power source supplying power to said perforated outer electrode and said center electrode; and
(b) a plurality of airflow stoppers, said airflow stopper being located between adjacent lateral-flow reacting units to prevent air from flowing back.

2. The device according to claim 1,
wherein said lateral-flow DBD reactor units have a connection selected from a group consisting of a serial connection, a parallel connection and a serial-and-parallel connection; and
wherein said lateral-flow DBD reactor units have a waste gas processing rate greater than 90 percents (%).

3. The device according to claim 2,
wherein said lateral-flow DBD reactor units has an arrangement selected from a group consisting of an interlaced arrangement and a non-interlaced arrangement.

4. The device according to claim 1,
wherein said lateral-flow DB D reactor unit has a discharge gap with a crossing width between 1.5 cm and 5 cm.

5. The device according to claim 1,
wherein said cylinder tube is made by a metal sheet and said metal sheet is made of a metal conductive material;
wherein said metal conductive material is an alloy of a material selected from a group consisting of stainless steel, copper, iron and aluminum;
wherein said cylinder tube has a length between 60 and 150 centimeters (cm); and a diameter between 8 and 10 cm; and
wherein said metal plate has a thickness between 0.8 and 3 millimeters.

6. The device according to claim 1,
wherein said fixing flange has a plurality of holes to be fixed and grounded; and
wherein said fixing flange is made of a metal conductive material.

7. The device according to claim 1,
wherein said through hole has a diameter between 0.5 cm and 1 cm; and
wherein said through holes have a total area between 40% and 60% of a surface of said cylinder tube; and
wherein said through holes obtains a uniformity in discharging.

8. The device according to claim 1,
wherein said center electrode is a rod made of a metal conductive material and said metal conductive material is an alloy of a material selected from a group consisting of stainless steel and copper; and
wherein said center electrode has a diameter between 0.5 cm and 3 cm.

9. The device according to claim 1,
wherein said insulating layer is a tube made of an insulating material and said insulating material is selecting from a group consisting of polytetrafluoroethylene (PTFE), polyethylene (PE), ceramics, glass and quartz; and
wherein said insulating layer has a thickness between 0.3 cm and 1.5 cm.

10. The device according to claim 1,
wherein said high voltage power source is selected from a group consisting of a variable frequency high voltage alternating current (HVAC) power source and a high frequency HVAC power source; and
wherein said high voltage power source has an operating voltage between 10 kilo-volts (kV) and 60 kV, and an operating frequency between 50 and 10 kHz.

11. The device according to claim 1,
wherein said airflow stopper is made of a material selected from a group consisting of a metal material or an insulting material; and
wherein said airflow stopper is selected from a group consisting of a plate stopper and a ‘V’-shaped stopper.
